(19) United States
(12) Patent Application Publication
(10) Pub. No.: US 2018/0252574 A1
(43) Pub. Date: Sep. 6, 2018

(54) SOUND VELOCITY SENSOR FOR UNDERWATER USE AND METHOD FOR DETERMINING UNDERWATER SOUND VELOCITY

(71) Applicant: AML Oceanographic Ltd., Sidney (CA)

(72) Inventors: Chris Bueley, Sidney (CA); Dustin Olender, Sidney (CA); Chris Paynter, Sidney (CA); Kyle Cameron, Sidney (CA)

(21) Appl. No.: 15/887,743

(22) Filed: Feb. 2, 2018

Related U.S. Application Data
(63) Continuation-in-part of application No. PCT/CA2017/050286, filed on Mar. 2, 2017.

(51) Int. Cl. G01H 5/00; G01S 15/58

(52) U.S. Cl. CPC G01H 5/00; G01S 15/588

(57) ABSTRACT

A sound velocity sensor for underwater use has an acoustic transmitter and receiver, a path length portion defining an acoustic path and positioned such that a generated acoustic signal propagates along the acoustic path from the acoustic transmitter to the receiver, a temperature sensor in direct contact with the path length portion, and a controller communicatively coupled to these components. The controller is configured to generate the acoustic signal using the acoustic transmitter, determine a transit time of the acoustic signal from the acoustic transmitter to the acoustic receiver, determine a temperature of the path length portion using the temperature sensor, and determine the velocity of the acoustic signal from the transit time and a length of the acoustic path. Determining the velocity includes compensating for a temperature-related change in the length of the acoustic path using the temperature of the path length portion.

### TECHNICAL FIELD

The present disclosure is directed at a sound velocity sensor for underwater use and at a method for determining underwater sound velocity.

### BACKGROUND

A sound velocity sensor is a device used to measure the velocity of sound in a particular medium. Certain types of sound velocity sensors are designed for underwater use, which permits them to measure the velocity of sound as it propagates through water. The velocity of sound in water varies with parameters such as the salinity and temperature of the water. While in some applications a rough approximation for the velocity of sound in water (e.g., 1,500 m/s) may be adopted without practical detriment, in other applications a more accurate measurement may be preferred or required.

### SUMMARY

According to a first aspect, there is provided a sound velocity sensor for underwater use. The sound velocity sensor comprises an acoustic transmitter for generating an acoustic signal; an acoustic receiver for receiving the acoustic signal; a path length portion defining an acoustic path and positioned such that the acoustic signal propagates along the acoustic path from the acoustic transmitter to the acoustic receiver; a temperature sensor in direct contact with the path length portion; and a controller communicatively coupled to the temperature sensor, acoustic transmitter, and acoustic receiver. The controller is configured to generate the acoustic signal using the acoustic transmitter; determine a transit time of the acoustic signal from the acoustic transmitter to the acoustic receiver; determine a temperature of the path length portion using the temperature sensor; and determine the velocity of the acoustic signal from the transit time and a length of the acoustic path. Determining the velocity comprises compensating for a temperature-related change in the length of the acoustic path using the temperature of the path length portion.

The temperature sensor may be partially or entirely embedded within the path length portion.

The sound velocity sensor may further comprise a base. The base may comprise a logging board communicatively coupled to the controller. The acoustic transmitter, the acoustic receiver, the path length portion, and the temperature sensor may comprise part of a sensor head that is releasably couplable to the base.

The controller may comprise part of the sensor head. Alternatively, the controller may comprise part of the base.

The controller may compensate for the temperature-related change in length of the acoustic path by determining an uncompensated velocity value without taking into account the temperature of the path length portion determined using the temperature sensor; and scaling the uncompensated velocity value by a temperature scaling factor determined using a coefficient of thermal expansion of the path length portion and the temperature of the path length portion.

The acoustic signal may propagate from the acoustic transmitter to the acoustic receiver without being reflected.

Alternatively, the acoustic transmitter and acoustic receiver may comprise part of an acoustic transducer, and the path length portion may comprise an acoustic reflector positioned to direct a reflection of the acoustic signal back to the acoustic transducer.

The controller may be further configured to determine a maximum amplitude of the reflection; compare the maximum amplitude to a reflection threshold; and when the maximum amplitude is less than the reflection threshold, generate another acoustic signal of larger amplitude than the acoustic signal that is the source of the reflection.

The reflection may comprise a first reflection. The acoustic signal may reverberate between the acoustic transducer and the acoustic reflector, and reverberations between the acoustic transducer and the acoustic reflector may comprise the first reflection and a second reflection of the acoustic signal off the acoustic reflector. Determining the transit time may comprise determining a time difference between receiving the first and second reflections at the acoustic transducer.

The first and second reflections may be the first and second reflections of the acoustic signal that the acoustic transducer receives.

Determining the time difference between receiving the first and second reflections may comprise performing a cross-correlation of the first and second reflections.

Determining the transit time of the acoustic signal may comprise obtaining and averaging samples of the acoustic signal, determining the temperature of the path length portion may comprise obtaining and averaging samples of the temperature as measured by the temperature sensor, and the temperature may be sampled at a higher frequency than the acoustic signal.

According to another aspect, there is provided a method for determining underwater sound velocity. The method may comprise generating an acoustic signal underwater; directing the acoustic signal along an underwater acoustic path, wherein the acoustic path is defined by a path length portion that directly contacts a temperature sensor; determining a transit time of the acoustic signal along the acoustic path; determining a temperature of the path length portion using the temperature sensor; and determining the velocity of the acoustic signal from the transit time and a length of the acoustic path. Determining the velocity may comprise compensating for a temperature-related change in the length of the acoustic path using the temperature of the path length portion.

The temperature sensor may be partially or entirely embedded within the path length portion.

Compensating for the temperature-related change in the length of the acoustic path may comprise determining an uncompensated velocity value without taking into account the temperature of the path length portion determined using the temperature sensor; and scaling the uncompensated velocity value by a temperature scaling factor determined using a coefficient of thermal expansion of the path length portion and the temperature of the path length portion.

Directing the acoustic signal may be done without reflecting the acoustic signal. Alternatively, directing the acoustic signal may comprise reflecting the acoustic signal back towards a source of the acoustic signal.

The method may further comprise determining a maximum amplitude of a reflection resulting from reflecting the acoustic signal; comparing the maximum amplitude to a reflection threshold; and when the maximum amplitude is less than the reflection threshold, generating another acoustic signal of larger amplitude than the acoustic signal that is the source of the reflection.

Reflecting the acoustic signal may cause the acoustic signal to reverberate along the acoustic path. Reverberations may comprise a first reflection and a second reflection. Determining the transit time may comprise determining a time difference between receiving the first and second reflections at an acoustic receiver.

The first and second reflections may be the first and second reflections of the acoustic signal that the acoustic receiver receives.

Determining the time difference between receiving the first and second reflections may comprise performing a cross-correlation of the first and second reflections.

Determining the transit time of the acoustic signal may comprise obtaining and averaging samples of the acoustic signal, determining the temperature of the path length portion may comprise obtaining and averaging samples of the temperature as measured by the temperature sensor, and the temperature may be sampled at a higher frequency than the acoustic signal.

According to another aspect, there is provided a non-transitory computer readable medium having encoded thereon computer program code that is executable by a processor. The computer program code, when executed, causes the processor to perform the method of any of the foregoing aspects or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1A is a perspective view of a sound velocity sensor for underwater use, according to one embodiment.

FIG. 1B is a front elevation view of the sensor of FIG. 1A.

FIG. 1C is a side elevation view of the sensor of FIG. 1A.

FIGS. 1D and 1E are top plan and bottom plan views, respectively, of the sensor of FIG. 1A.

FIG. 1F is a sectional view of the sensor of FIG. 1A taken along line F-F of FIG. 1C.

FIG. 1G is an exploded view of the sensor of FIG. 1A.

FIG. 2A is a block diagram of a sound velocity sensor for underwater use, according to another embodiment.

FIG. 2B is a block diagram if a sound velocity sensor for underwater use, according to the embodiment of FIGS. 1A-G.

FIG. 3 is a flowchart for a method for determining underwater sound velocity, according to another embodiment.

FIGS. 4A-C are waveforms of a generated acoustic signal and reflections thereof recorded by the sensor of FIGS. 1A-G.

FIGS. 5A-B depict a data flow diagram for a method for determining underwater sound velocity, according to another embodiment.

FIGS. 6A-C depict a flowchart for the method for determining underwater sound velocity of FIGS. 5A-B.

### DETAILED DESCRIPTION

Sound velocity (hereinafter interchangeably referred to as the “speed of sound”) is defined as the distance travelled per unit of time by a sound wave as it propagates through a medium. Sound velocity is not constant across different types of media located in different environments. For example, sound travels at a different velocity in water than in air, and even within the same medium travels at a different velocity at one temperature than another.

A sound velocity sensor for underwater use (hereinafter interchangeably referred to as an “underwater sound velocity sensor”) may be used to measure the velocity of sound in water. In one type of underwater sound velocity sensor, a sound wave is generated and the amount of time the wave takes to propagate a certain and known distance is measured. Given the known distance and measured propagation time, an estimate for the sound velocity may be determined.

The embodiments herein are directed at an underwater sound velocity sensor and at a method for determining underwater sound velocity. The sensor and method determine underwater sound velocity by measuring the amount of time required for a sound wave to propagate a path length. A temperature sensor is placed in direct contact with a path length portion, which defines the path length. This allows a controller to obtain an accurate measurement of the temperature of the path length portion. The controller obtains the coefficient of thermal expansion (“CTE”) of the path length portion and, combined with the measured temperature and a reference path length corresponding to a reference temperature of the path length portion, determines any change in path length resulting from a difference between the measured and reference temperatures. This allows the controller to compensate for a temperature related expansion or contraction of the path length, which increases accuracy of the sound velocity measurement. The sound wave may propagate along the acoustic path without being reflected; alternatively, a reflector may be located along the acoustic path and be used to reflect the sound wave, for example, back towards its source.

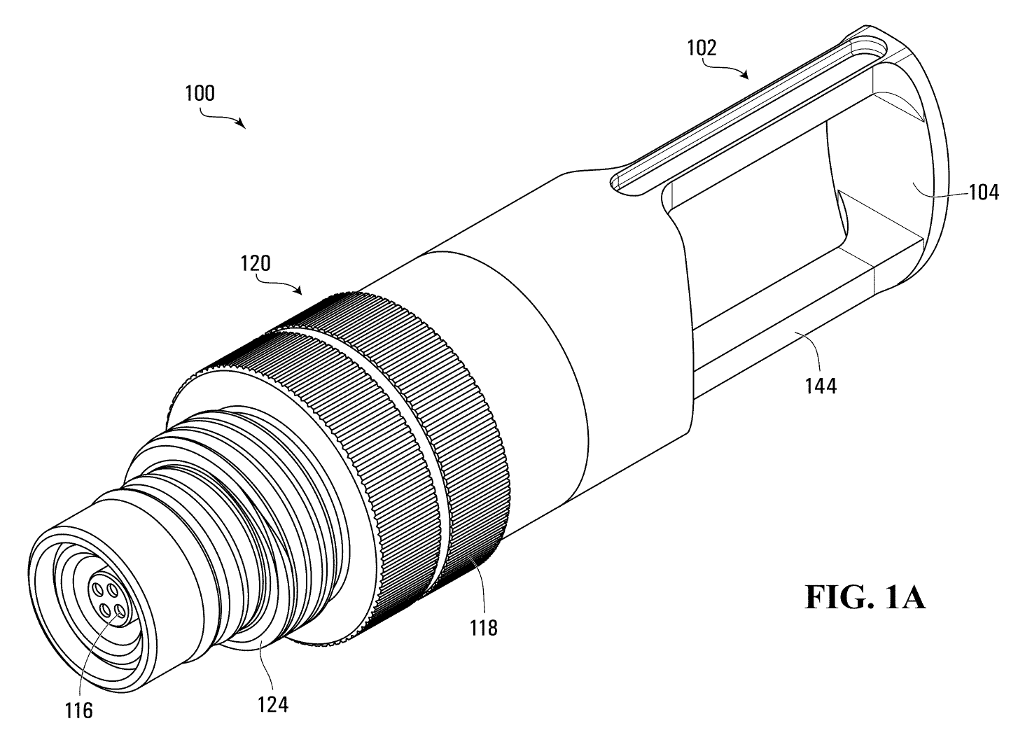

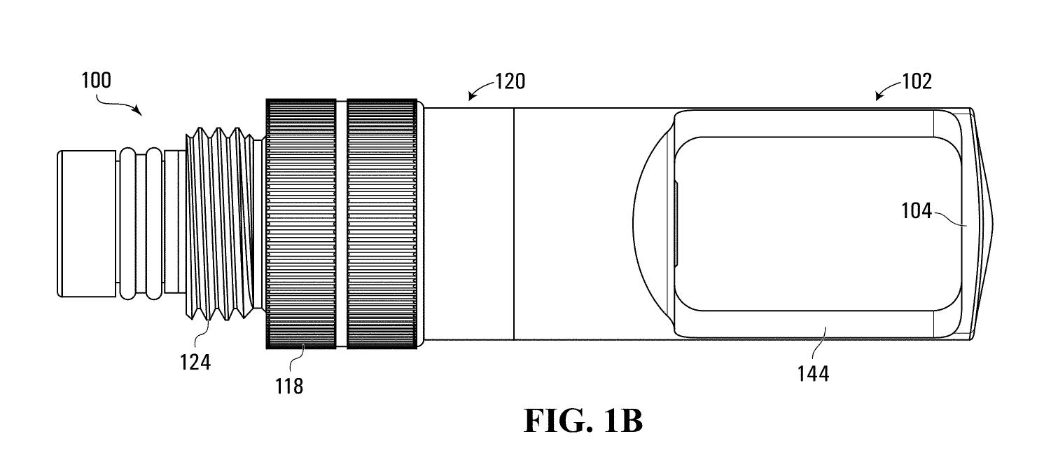

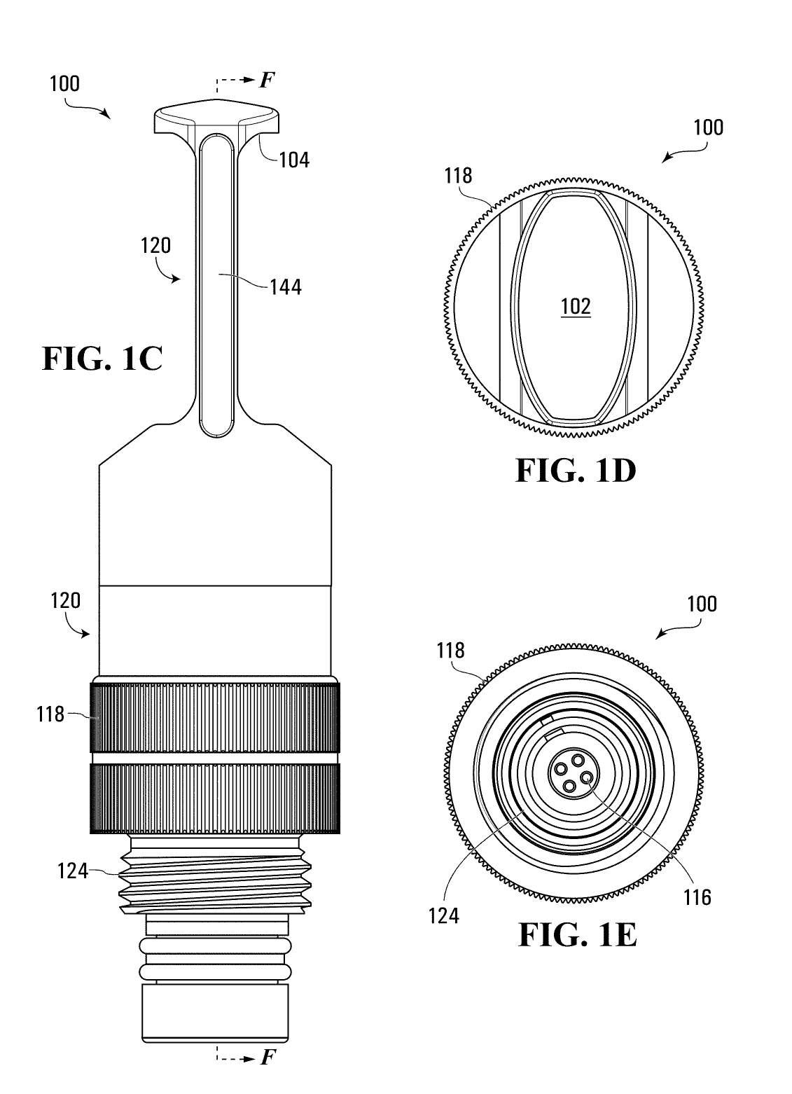

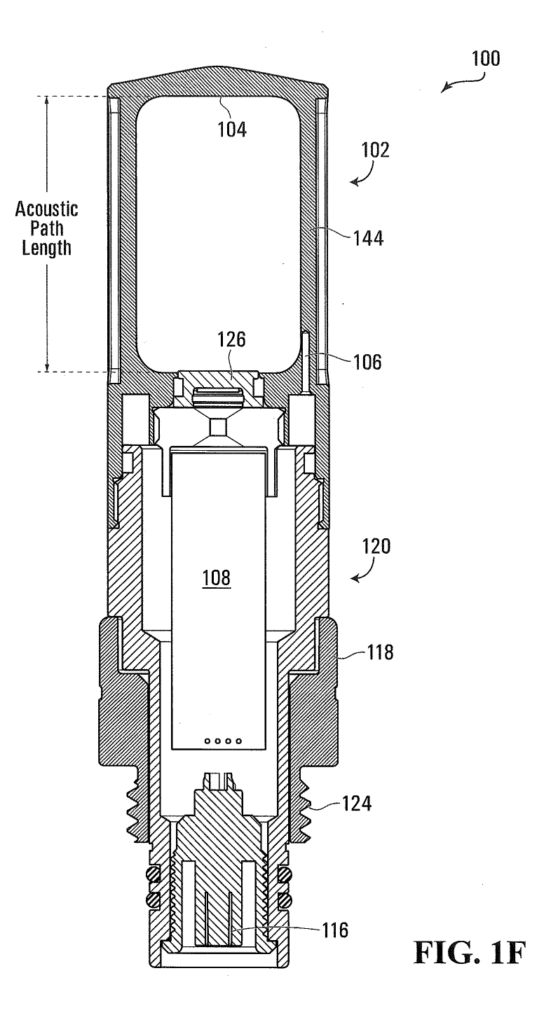

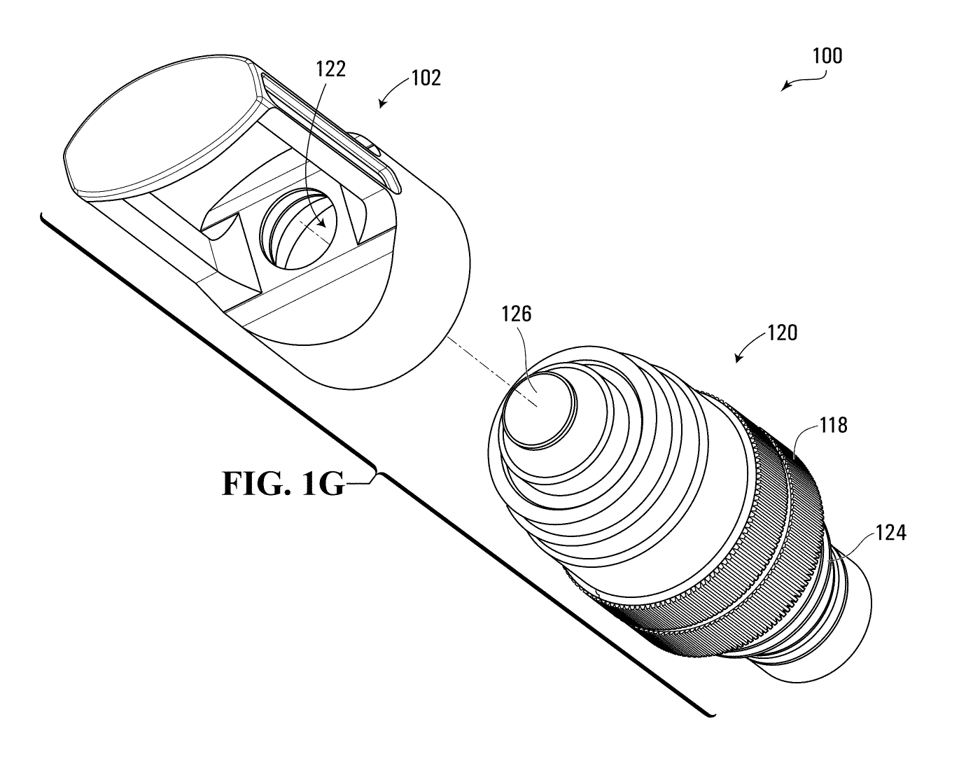

FIGS. 1A-G show various views of a sound velocity sensor 100 for underwater use, according to one embodiment. FIG. 1A is a perspective view of the sensor 100; FIGS. 1B is a front elevation view of the sensor 100; FIG. 1C is a left side elevation view of the sensor 100; FIGS. 1D and 1E are top plan and bottom plan views, respectively, of the sensor 100; FIG. 1F is a sectional view of the sensor 100 taken along line F-F of FIG. 1C; and FIG. 1G is an exploded view of the sensor 100. Due to rotational symmetry, the rear elevation and right side elevation views of the sensor 100 are substantially similar to the front elevation and left side elevation views shown in FIGS. 1B and 1C, respectively.

The sensor 100 generally comprises a transducer portion 120 on which is mounted a path length portion 102. As shown in FIGS. 1F and 1G, an annular snap-fit secures the base of the path length portion 102 to the top of the transducer portion 120. The path length portion 102 is passive and is manufactured from a material with a low but non-negligible CTE, such as titanium. At the base of the path length portion 102 is a transducer aperture 122 for receiving an acoustic transducer 126 that is at the top of the transducer portion 120. Extending away from the transducer aperture 122 are a pair of arms 144 at the end of which is an acoustic reflector 104. The arms 144 define along their lengths an acoustic path having a length hereinafter referred to as an “acoustic path length”, as noted in FIG. 1G. An acoustic signal generated by the transducer 126 accordingly propagates along the acoustic path until it strikes the reflector 104, causing a reflection of the signal to propagate along the acoustic path in an opposite direction while returning to the acoustic transducer 126. The reflection may again reflect off the acoustic transducer 126, causing acoustic reverberations to travel repeatedly back and forth along the acoustic path. The acoustic path length may be any suitable length, and in the depicted embodiment is approximately 1.31 inches (3.33 cm). As used herein, a reference to receiving or measuring the acoustic signal generated by the transducer 126 refers to receiving an unreflected version of the acoustic signal as well as a first or subsequent reflection of the acoustic signal.

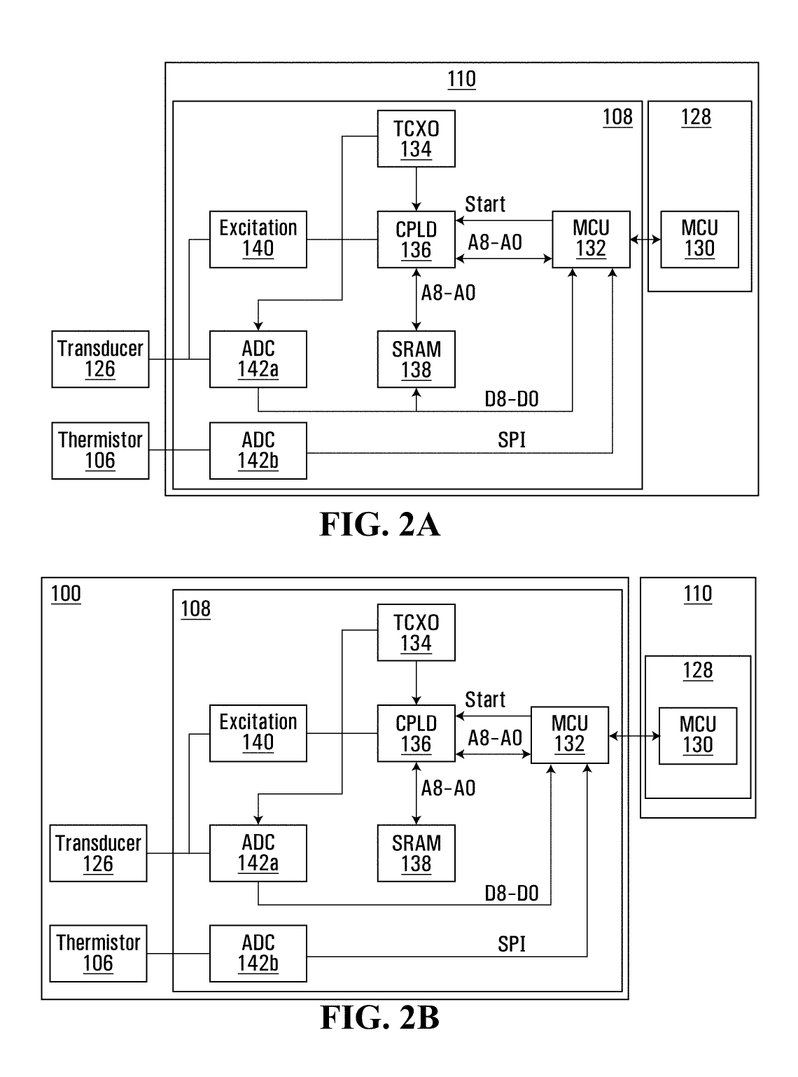

The transducer portion 120 comprises at its top end the acoustic transducer 126 and at its bottom end a threaded male connector 124 terminating in a communications port 116. Between and communicatively coupled to each of the transducer 126 and port 116 is a controller 108 that comprises an embedded circuit board (“sensor board”), as discussed in further detail in FIG. 2B below. A knurled grip 118 circumscribes the transducer portion 120 and facilitates holding the sensor 100 and inserting and removing the sensor 100 into a base 110 (depicted in and discussed further in relation to FIGS. 2A and 2B, below).

A thermistor 106, which is an example type of temperature sensor and which is visible in FIG. 1F, is communicatively coupled to the controller 108 and is in direct contact with the path length portion 102. More specifically, the thermistor 106 is embedded entirely within the path length portion 102. Placing the thermistor 106 in direct contact with the path length portion 102 permits the thermistor 106 to accurately measure the path length portion's 102 temperature, which facilitates accurate temperature compensation.

Referring now to FIGS. 2A and 2B, there are shown block diagrams of the sensor 100 according to two embodiments. The embodiment of FIG. 2B is the embodiment depicted in FIGS. 1A-G, while the embodiment of FIG. 2A is a different embodiment.

Referring first to FIG. 2B, the sensor 100 comprises the controller 108 in the form of the sensor board, the acoustic transducer 126, and the thermistor 106. The controller 108, transducer 126, and thermistor 106 comprise part of a sensor head, which is what is depicted in FIGS. 1A-G. The sensor head is releasably couplable into the base 110, which comprises a logger board 128 for logging sensor measurements. In the embodiment of FIGS. 1A-G, the threaded male connector 124 is screwed into a female connector (not depicted) comprising part of the base 110. The sensor measurements comprise one or both of temperature and sound velocity measurements.

Each of the controller 108 and logger board 128 comprises a microcontroller (the microcontroller on the controller 108 is hereinafter the “sensor board microcontroller 132” and the microcontroller on the logger board 128 is hereinafter the “logger board microcontroller 130”). The microcontrollers 128,130 are communicatively coupled to each other via the communications port 116. The controller 108 also comprises a complex programmable logic device (“CPLD”) 136, memory 138 in the form of static random access memory (“SRAM”), excitation circuitry 140 for exciting the transducer 126, an oscillator 134, a first and a second analog-to-digital converter (“ADC”) 142a,b, the acoustic transducer 126, and the thermistor 106. The transducer 126 and thermistor 106 send analog readings to the first and second ADCs 142a,b, respectively, for conversion into digital signals that are communicated to the sensor board microcontroller 132. The first ADC 142a is communicatively coupled to the sensor board microcontroller 132 and to the memory 138 via a 9-pin data bus D8-D0 while the second ADC 142b is communicatively coupled to the sensor board microcontroller 132 via a Serial Peripheral Interface (“SPI”) bus. The CPLD 136 is also communicatively coupled to the sensor board microcontroller 132 via a 9-pin bus address A8-A0 and a start line, to the memory 138 via another 9-pin address bus A8-A0, and to the excitation circuitry 140. The oscillator 134 is communicatively coupled to the CPLD 136 and the ADCs 142a,b. The excitation circuitry 140 is communicatively coupled in parallel to the transducer 126 with the first ADC 142a.

The acoustic transducer 128 may comprise a piezoelectric element and the excitation circuitry may comprise a piezoelectric driver integrated circuit. Each of the microcontrollers 128,130 may comprise an STMicroelectronics™ STM32L476 microcontroller. Firmware may be developed for the microcontrollers 128,130 using the Attolic TrueSTUDIO™ integrated development environment and the STMicroelectronics STM32CubeMX™ and GCC toolchains. The CPLD 136 may be programmed using Altium Designer™ software. Each of the microcontrollers 128,130 comprises a processor and a memory (neither shown), such as EEPROM, communicatively coupled together, with the memory having stored thereon computer program code for execution by the processor.

Referring now to the different embodiment of FIG. 2A, the sensor head comprises the transducer 126 and the thermistor 106, while the base 110 comprises the controller 108 and logger board 128 as described above. In this embodiment, some of the hardware 0responsible for the functionality of the sensor 100 of FIG. 2B is shifted to the base 110, which is typically larger than the sensor head. This may alleviate issues related to miniaturization that may result from designing the controller 108 to fit within the sensor head.

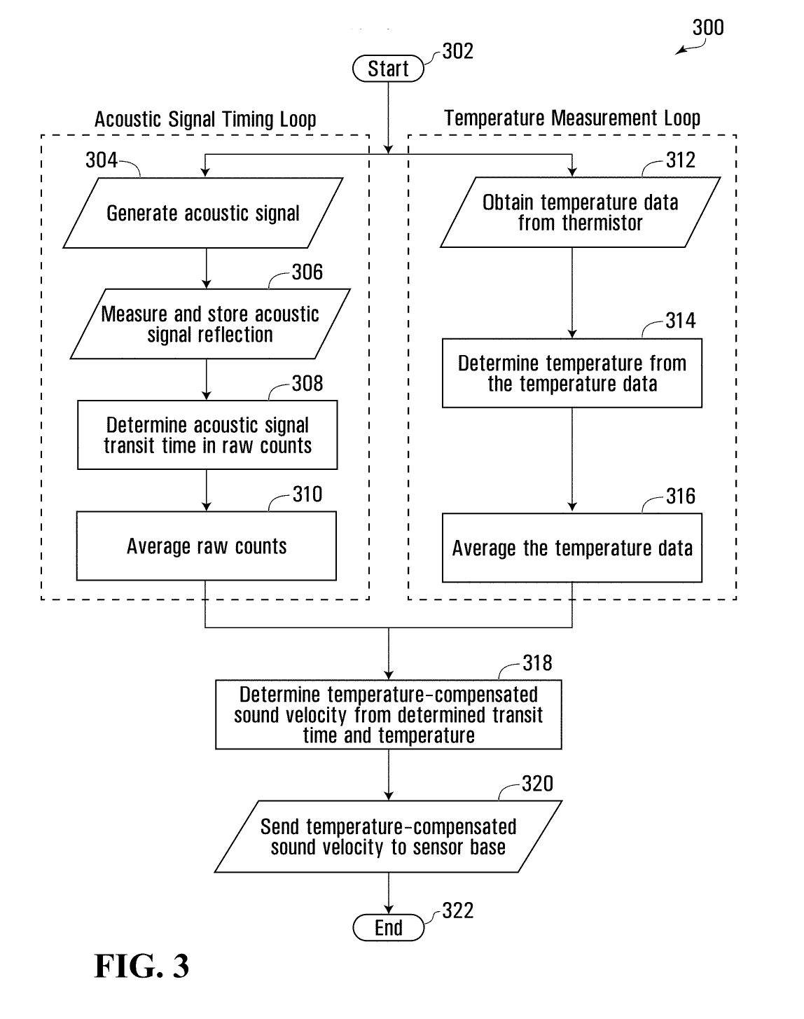

Referring now to FIG. 3, there is shown a flowchart for a method 300 for determining underwater sound velocity, according to another embodiment. The method 300 may be expressed as one or both of computer program code and a configuration of logic gates and subsequently be performed by the controller 108. More particularly, any computer program code may be stored on to the memory comprising part of the sensor board microcontroller 132, and the CPLD 136 may be suitably configured to permit one or both of the CPLD 136 and microcontroller 132 to perform the method 300 as described in further detail below.

The method 300 begins at block 302 and proceeds to two loops: an acoustic signal timing loop and a temperature measurement loop. While the method 300 depicts the loops as being performed in parallel using, for example, some type of context switching, in different embodiments (not depicted) they may instead be performed sequentially.

In the acoustic signal timing loop, the controller 108 first generates the acoustic signal at block 304. This is done by having the sensor board microcontroller 132 send a start pulse over the start line to the CPLD 136. In response, the CPLD 136 provides a ping pulse to the excitation circuitry 140, which the transducer 126 translates into physical vibration that corresponds to the acoustic signal. The acoustic signal and reflections thereof reverberate along the acoustic path defined by the arms 144, between the acoustic transducer 126 and reflector 104 as described above. Reflections of the acoustic signal impact the transducer 126, which consequently generates an electrical signal that the first ADC 142a digitizes and sends to the memory 138 for storage. On each cycle of the oscillator 134, the CPLD 136 sends a new address to the memory 138 via the address bus so that each sample from the first ADC 142a is stored in a new memory location. Once data acquisition is complete, the CPLD 136 ends excitation of the transducer 126 and hands over the address bus to the sensor board microcontroller 132 and waits for another start signal from the microcontroller 132 before generating another acoustic signal and acquiring more data. The CPLD 136 may wait a certain period of time before assuming the data acquisition is complete (e.g., the period of time required for reverberations to decrease to approximately zero amplitude) or may continuously compare measured values to a minimum threshold in order to determine that data acquisition is complete. The sensor board microcontroller 132 subsequently addresses the memory 138 using the address buses via the CPLD 136, and acquires data from the memory 138 via the data bus.

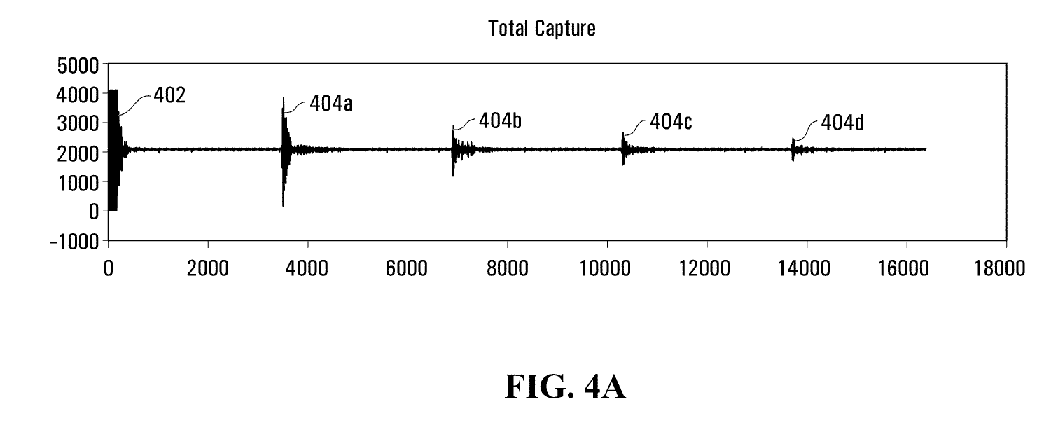

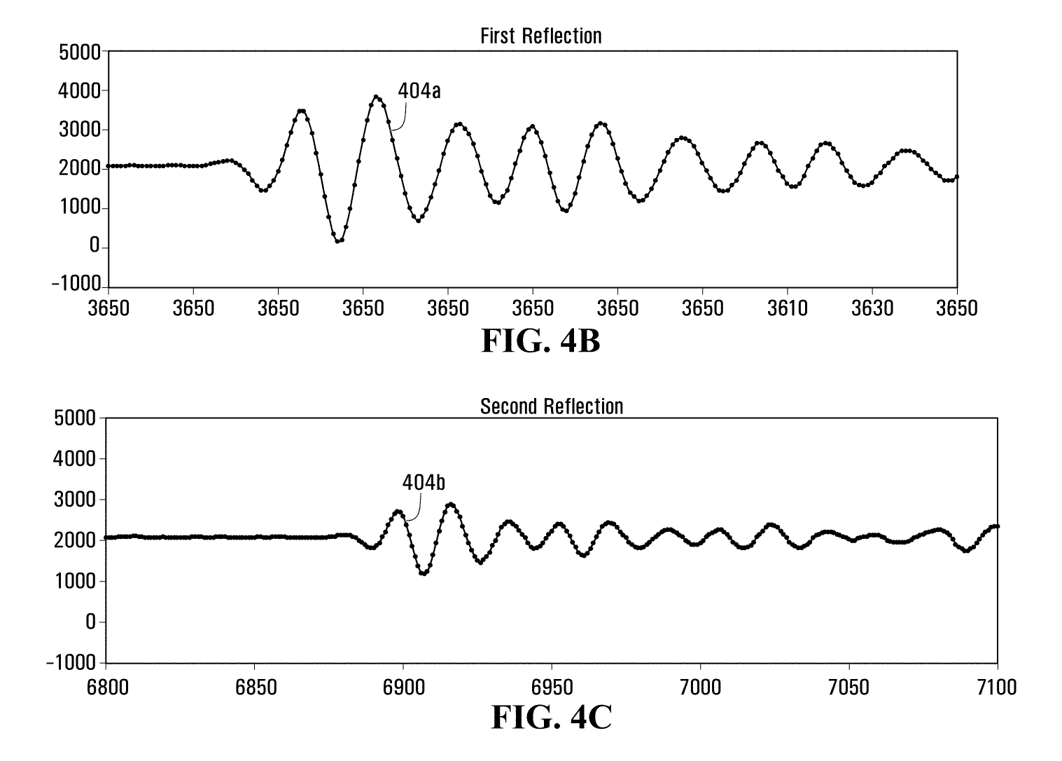

FIGS. 4A-C depict waveforms of the acoustic signal and reflections thereof as output by the first ADC 142a and stored in the memory 138. The vertical axis is the output of the ADC 142a, which clips at 4,096. The horizontal axis is the sample number. The acoustic signal generated directly from the transducer 126 is digitally represented by a measured signal pulse 402, while the first through fourth reflections are digitally represented by first through fourth measured reflection pulses 404a-d. FIG. 4A depicts all of the pulses 402,404a-d, while FIG. 4B focuses on the first measured reflection pulse 404a and FIG. 4C focuses on the second measured reflection pulse 404b.

It may be beneficial for the measured reflection pulses 404a-d to have a high amplitude without clipping the ADC 142a. To accomplish this, the controller 108 determines a maximum amplitude of the first reflection pulse 404a and compares that amplitude to a reflection threshold. For example, in FIG. 4A the amplitude of the first measured reflection pulse 404a is approximately 3,800. In an embodiment in which the reflection threshold is 3,500, the controller 108 takes no action specifically in response to determining that the first measured reflection pulse's 404a maximum amplitude exceeds the reflection threshold. In an embodiment in which the reflection threshold is 4,000, once the reverberations cease the controller 108 increases the amplitude of the acoustic signal by, for example, increasing the voltage applied across the piezoelectric element. The voltage increase may be in terms of a percentage increase relative to the voltage used to generate the acoustic signal that generated the 3,800 magnitude reflection pulse, or may be in terms of an absolute amount (e.g, a 0.5 V increase). The controller 108 then measures the reflections resulting from generating this acoustic signal of larger amplitude and again compares the maximum amplitude of the first measured reflection pulse 404a to the reflection threshold, and again generates a larger amplitude acoustic signal if that maximum amplitude is less than that threshold. While in these examples the controller 108 uses the maximum amplitude of the first measured reflection pulse 404a to determine whether the acoustic signal's magnitude is to be increased, in different embodiments (not depicted) a different measured reflection pulse may be used (e.g., any one of the second through fourth pulses 404b-d) and the maximum amplitude of that pulse need not be used. For example, the RMS value of the pulse may be instead be used.

Concurrently with block 306, the controller 108 in the temperature measurement loop performs block 312, and obtains temperature data from the thermistor 106 via the second ADC 142b. The second ADC 142b sends digitized temperature data directly to the sensor board microcontroller 108. In a different embodiment the temperature data may also be sent to the memory 138.

At blocks 308 and 314, the controller 108 determines acoustic signal transmit time in terms of number of samples (referred to as “raw counts” in FIG. 3) and the temperature of the path length portion 102 from the digital temperature data, respectively. In one embodiment, at block 308 the controller 108 determines acoustic signal transit time by determining the time difference between the absolute maxima (the highest peak) of any two of the measured reflection pulses 404a-d. In another embodiment, at block 308 the controller 108 determines acoustic signal transit time by determining the time difference between two corresponding portions of any two of the measured reflection pulses 404a-d (e.g., the beginnings or endings, or corresponding local maxima or minima, of any two of the pulses 404a-d). In the depicted embodiment, the acoustic signal transit time is determined by performing a cross-correlation of two of the reflection pulses 404a-d or corresponding portions thereof. In another embodiment (not depicted), the acoustic signal transit time may be determined by measuring the difference between any two consecutive reflections represents the time required for the acoustic signal to travel twice the acoustic path length. In another embodiment (not depicted), the acoustic signal transit time may be determined by determining the time difference between the measured signal pulse 402 and one or more of the measured reflection pulses 404a-d.

At block 314, the controller 108 obtains the raw output of the thermistor via the SPI bus and determines the temperature from that output using, for example, a polynomial transfer function or the Steinhart-Hart Equation.

Example output from blocks 308 and 314 is presented below in Table 1, with each row of values corresponding to a different acoustic signal.

TABLE 1
Example Acoustic Signal Transit Times and
Temperatures for Fifteen Different Acoustic Signals

| | Raw Counts | Raw | Sensor |
|---|---|---|---|
| Acoustic | Between First and | Thermistor | Temperature |
| Signal | Second Reflections | Output | (° C.) |
| First | 3711.098 | 376054 | 2.348212 |
| Second | 3711.08 | 376057 | 2.348508 |
| Third | 3711.079 | 376069 | 2.349367 |
| Fourth | 3711.076 | 376071 | 2.349794 |
| Fifth | 3711.067 | 376065 | 2.349022 |
| Sixth | 3556.813 | 563513 | 18.31888 |
| Seventh | 3556.804 | 563520 | 18.31993 |
| Eighth | 3556.804 | 563520 | 18.31993 |
| Ninth | 3556.798 | 563526 | 18.3196 |
| Tenth | 3556.793 | 563539 | 18.32002 |
| Eleventh | 3483.733 | 699281 | 30.06825 |
| Twelfth | 3483.733 | 699281 | 30.06825 |
| Thirteenth | 3483.743 | 699293 | 30.06996 |
| Fourteenth | 3483.728 | 699299 | 30.0727 |
| Fifteenth | 3483.741 | 699284 | 30.0693 |

At blocks 310 and 316, the controller averages the transit time values in raw counts and the temperature. Averaging may be done differently, depending on the embodiment.

In one embodiment, the controller 108 and, more particularly, the sensor board microcontroller 132, applies a simple moving average of the last N transit time values in raw counts and the last M determined temperatures, with N and M optionally, but not necessarily, equalling each other. In certain embodiments, M<N to facilitate more accurate temperature data. Using the data of Table 1, for N=5 and M=2, the output immediately after the fifth acoustic signal of block 310 is 3711.08 and block 316 is 2.349408° C. In the depicted embodiment, for each generated acoustic signal the controller 108 updates the transit time and temperature averages. Furthermore, while in this example a simple moving average is used, in different embodiments a different type of averaging may be used, or no averaging at all may be used. Examples different types of averages are a cumulative average of all recorded data to date, a weighted average (moving or otherwise), and an exponential average (moving or otherwise).

At block 318, the controller 108 and, more particularly, the sensor board microcontroller 132, determines a temperature-compensated sound velocity from the determined transit time and temperature. In the depicted embodiment, the determined transit time and temperature are the averages output by blocks 310 and 316. Using the example above, immediately following the fifth acoustic signal the determined transit time is 3711.08 raw counts and the associated temperature reading is 2.349408° C.

The time corresponding to the number of raw counts can be determined using the sampling frequency. In this example embodiment, the sampling frequency is 77.76 MHz. Consequently, the time corresponding to 3711.08 raw counts is 47.725 μs. The total distance traveled corresponding to this time is twice the acoustic path length, which in this example is 3.33 cm; total travel distance is consequently 6.66 cm. Traveling 6.66 cm in 47.725 μs corresponds to a velocity of 1395.49 m/s, before performing any temperature compensation (this velocity is the “uncompensated velocity”).

The controller 108, and more particularly the sensor board microcontroller 132, adjusts the uncompensated velocity to take into account the temperature by applying Equation (1):

SV_{comp}=SV_{uncomp}·[1+CTE(T−T₀)] (1)

where SV_{comp} is the temperature-compensated sound velocity, SV_{uncomp} is the uncompensated sound velocity, CTE is the coefficient of thermal expansion of the arms 144, T is the measured temperature, and T₀ is a reference temperature for which the acoustic path length is the reference path length (i.e., the temperature at which any temperature-caused change in path length is deemed to be zero).

Assuming T₀ to be 0° C. in this example, applying Equation (1) where SV_{uncomp}=1395.49 m/s, T=2.349408° C., and the arms 144 are made of titanium having a CTE of 9.8×10⁻⁶/° C., SV_{comp}=1,395.52 m/s.

At block 320, the controller 108 and, more particularly, the sensor board microcontroller 132, outputs the temperature-compensated sound velocity to the sensor base 110 and, more particularly, the logger board microcontroller 130. The base 110 may subsequently output the temperature-compensated sound velocity to external memory. As discussed above, the base 110 in certain embodiments is not present, in which case the method 300 omits or modifies block 320, as appropriate. Additionally or alternatively, the controller 108 may output any or all of the raw data used to determine the temperature-compensated sound velocity, such as the raw data obtained from the thermistor 106 and transducer 126 and the averaged raw count and temperate data.

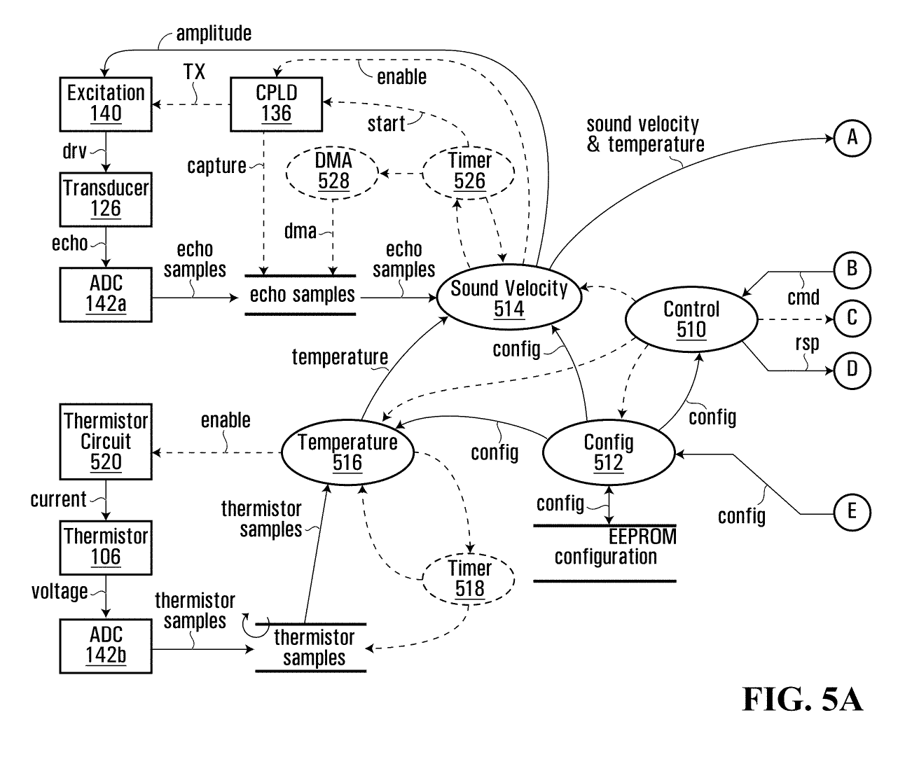

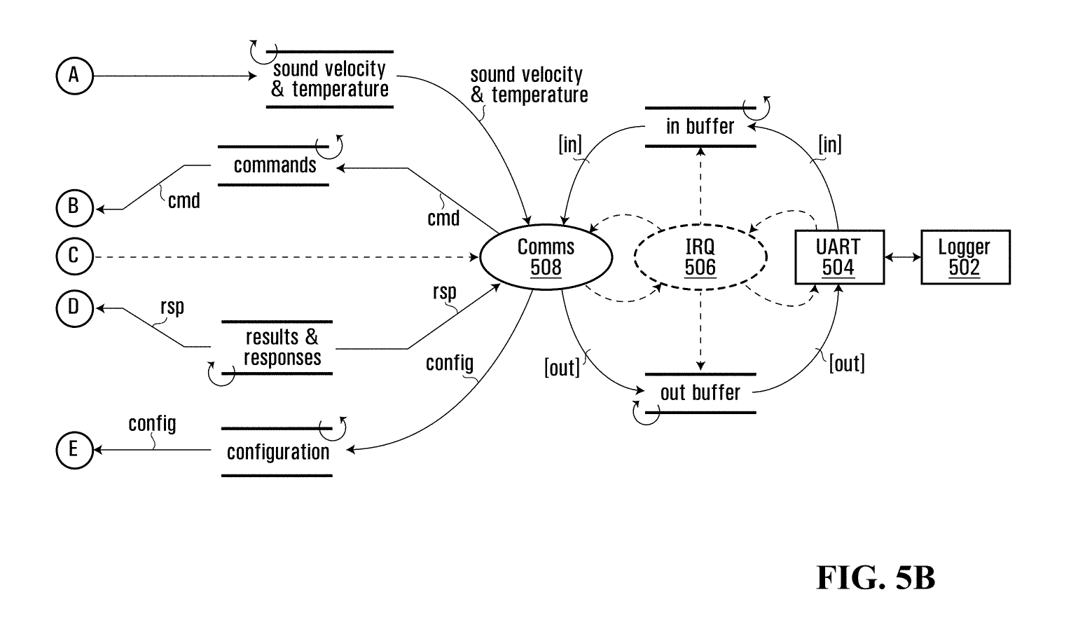

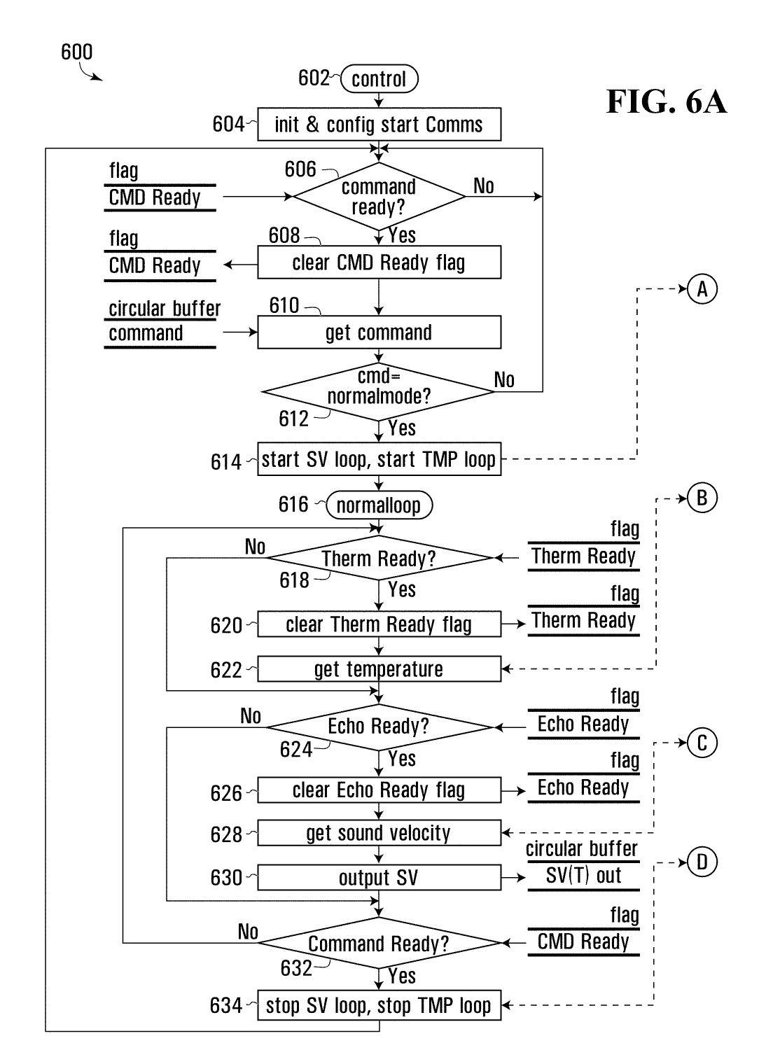

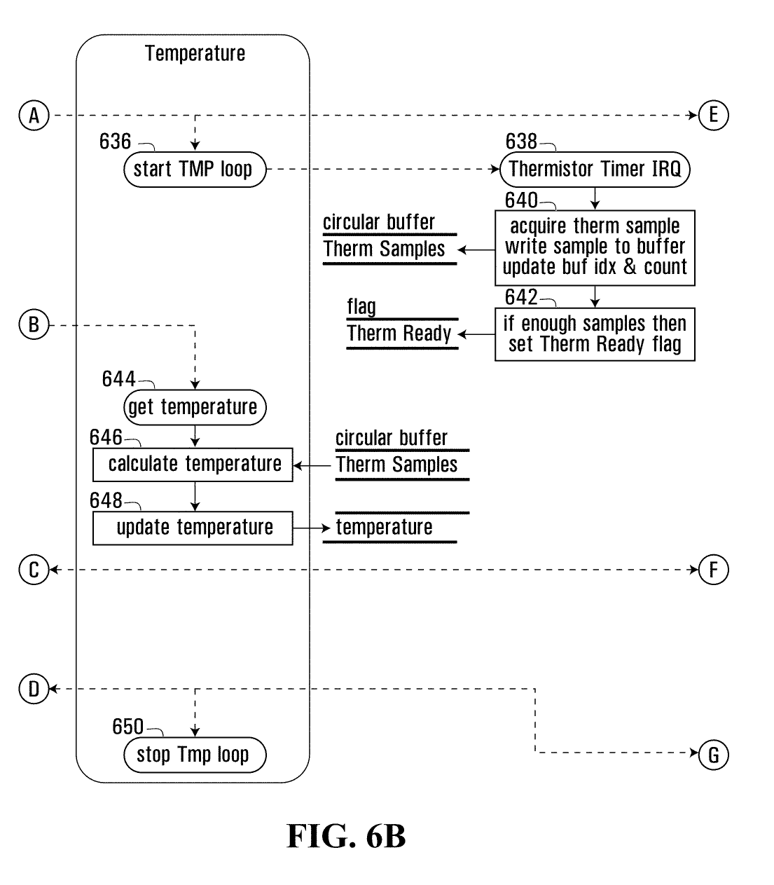

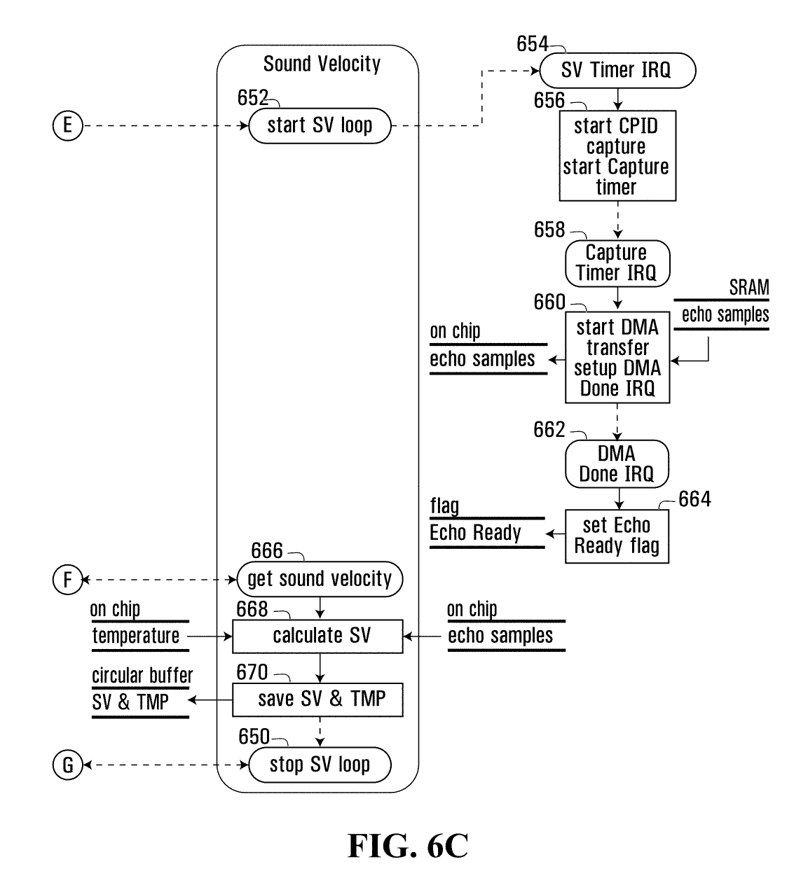

Referring now to FIGS. 5A-B, there is shown a data flow diagram 500 for a method 600 for determining underwater sound velocity, according to another embodiment. FIGS. 6A-C depict a flowchart for the method 600 to which the data flow diagram 500 of FIGS. 5A-B refer. As with the method 300 exemplified by the flowchart of FIG. 3, the method 600 of FIGS. 5A-B and 6A-C may be expressed as one or both of computer program code and a configuration of logic gates and subsequently be performed by the controller 108. More particularly, any computer program code may be stored on to the memory comprising part of the microcontroller 132, which is EEPROM in the context of FIGS. 5A-B and 6A-C, and the CPLD 136 may be suitably configured to permit one or both of the CPLD 136 and microcontroller 132 to perform the method 300 as described in further detail below.

At block 602, the controller 108 begins performing a control loop using a control process 510. The controller 108 proceeds to block 604 where it performs an initialization and configuration routine using a configuration process 512, which is bidirectionally communicative with the control process 510. The configuration process 512 obtains configuration data from and is also able to write configuration data to EEPROM. Example configuration data comprises information such as serial number, transmission rate, and firmware version.

At block 604 the controller 108 also starts communications using a communications process 508. The communications process 508 sends commands to the control process 510, and the control process 510 sends results and responses to the communications process 508. The communications process 508 sends configuration data to the configuration process 512, which writes that data to EEPROM as described above.

The communications process 508 is bidirectionally communicative with a UART 504 via an interrupt request (“IRQ”) 506, and also without using interrupts via in and out buffers. The UART 504 is bidirectionally communicative with a logger 502, which in the present example embodiment comprises the logger board 128.

At block 606, the controller 108 determines whether a command is ready to be performed. The controller 108 does this by checking to see whether a command ready (“CMD Ready”) flag has been set. Example commands comprise whether to enter a diagnostic mode in which all data the controller 108 obtains is output in raw form to the logger 502. Commands may be sent to the controller 108 via the logger 502. If no command is ready, the controller 108 returns to block 606 and awaits a command. If a command is ready, the controller 108 proceeds to block 608 where it clears the CMD Ready flag, and to block 610 where it gets the command from a circular buffer. At block 612, if the command is to enter “normal mode”, which in the depicted embodiment refers to the mode in which the temperature-compensated sound velocity is determined, the controller 108 proceeds to block 614 where it begins performing a sound velocity loop (“SV loop”) and a temperature loop (“TMP loop”). Otherwise, the controller 108 returns to block 606.

When the controller 108 enters the TMP loop, it proceeds to block 636 in the method 600 and a temperature process 516 in the data flow diagram 500. The temperature process 516 enables a thermistor circuit 520 that supplies current to the thermistor 106, which outputs raw temperature data (“thermistor samples” in the data flow diagram 500) to the first ADC 142a. The first ADC 142a outputs the thermistor samples to the temperature process 516. In the method 600, upon expiry of a thermistor timer at block 638 the controller 108 acquires samples at block 640 and stores them in a circular buffer. Once a sufficient number of samples has been acquired as determined at block 642, the controller 108 sets a “Therm Ready” flag. In the embodiment of FIG. 3 in which temperature data and the acoustic signal are sampled and averaged at identical rates, the “sufficient number” at block 642 is one. In different embodiments (not depicted), the rate at which temperature data and the acoustic signal are sampled, averaged, or both may differ. In one of these different embodiments, the temperature data may be sampled at a faster rate than the acoustic signal is, and an average of the temperature data may be used in order to reduce noise. For example, an embodiment in which the temperature data is sampled at a rate four times faster than the acoustic signal and an average of four temperature data samples are used for every sample of the acoustic signal, the “sufficient number” at block 642 is four.

When the controller 108 enters the SV loop, it proceeds to block 652 in the method 600 and a sound velocity process 514 in the data flow diagram 500. The sound velocity process 514 enables a timer process 526 and direct memory access (“DMA”) process 528 to directly access the memory 138. The timer process 526 runs a sound velocity timer (“SV Timer”) and a capture timer (“Capture Timer”). When SV Timer expires, an SV Timer IRQ is generated at block 654, following which the CPLD 136 generates the acoustic signal and begins to measure reflections (referred to as “echoes” in FIGS. 5A-6C) at block 656. This is reflected in the data flow diagram 500 by the sound velocity process 514 sending the amplitude of the acoustic signal to be generated to the excitation circuitry 140, which drives the transducer 126. The transducer 126 measures reflection pulses 404a-d and sends them to the first ADC 142a, which stores them in the memory 138. Once the Capture Timer expires, the CPLD 136 ceases to capture data from the transducer 126. The controller 108 proceeds to block 660 where the captured acoustic data in the form of raw counts is sent to the sensor board microcontroller's 132 memory from the memory 138 using the DMA process 528. Once that transfer is done, a “DMA Done” IRQ is made at block 662 and the controller 664 sets an “Echo Ready” flag at block 664. The acquired data is sent to the sound velocity process 514.

The controller 108 subsequently enters the normal loop at block 616 and proceeds to block 618 where it determines whether sufficient temperature data has been captured in order to generate a reliable temperature by checking the Therm Ready flag. If yes, the controller clears the Therm Ready flag at block 620 and proceeds to block 622 where it obtains the temperature. The controller 108 does this by performing a “get temperature” process at block 644. The controller 108 proceeds to block 646 where the temperature process 516 obtains thermistor samples stored at block 640 and determines the temperature at block 648, as discussed in respect of FIG. 3. The temperature process 516 sends the determined temperature to the sound velocity process 514.

Following obtaining the temperature, the controller 108 proceeds to block 624. In the event the Therm Ready flag is not set at block 618, the controller 108 proceeds directly to block 624 from block 618. At block 624, the controller 108 determines whether the Echo Ready flag is set. If it is, it proceeds to block 626 where it clears the Echo Ready Flag and to block 628 where it determines SV_{comp}. To determine SV_{comp}, the controller 108 performs a “get sound velocity” process at block 666. The controller 108 determines SV_{comp} at block 668 from the echo samples that are stored in the controller's 108 EEPROM and temperature reading as described above in respect of FIG. 3. The controller 108 at block 670 subsequently saves SV_{comp} and the temperature used to determine it in a circular buffer at block 670.

After SV_{comp} is determined, the controller 108 at block 630 outputs SV_{comp} to the logger 502 and proceeds to block 632 where it checks to see if another command is ready to be performed by checking the CMD Ready flag. If the Echo Ready flag is not set at block 624, the controller 108 proceeds directly to block 632 from block 624. If there is no new command ready to be performed, the controller 108 loops back to block 618. If a new command is ready to be performed, the controller 108 proceeds to block 634 where it stops the SV and TMP loops, and proceeds back to block 606.

While particular embodiments have been described in the foregoing, it is to be understood that other embodiments are possible and are intended to be included herein. It will be clear to any person skilled in the art that modifications of and adjustments to the foregoing embodiments, not shown, are possible. For example, in the depicted embodiments the acoustic transmitter and acoustic receiver are embodied by the single acoustic transducer 126. However, in different embodiments (not depicted), the acoustic transmitter and receiver may be distinct from each other.

As another example, in the depicted embodiments the reflector 104 reflects the acoustic signal so that the acoustic transducer receives reflections of the acoustic signal. However, in a different embodiment (not depicted) the acoustic signal may propagate from an acoustic transmitter to an acoustic receiver without being reflected. For example, the reflector 104 in the embodiment of FIGS. 1A-G may be replaced with an acoustic receiver, and the transit time of the acoustic signal may be the time it takes for the acoustic signal to travel once from the acoustic transducer 126 to the acoustic receiver.

As another example, the thermistor 106 in the depicted embodiments is embedded entirely within the path length portion 102 when the sensor 100 is assembled. In different embodiments (not depicted), the thermistor 106 may be differently positioned. For example, in one different embodiment the thermistor 106 may be positioned on the outside of the sensor 100 and be directly exposed to water when in use. In another different embodiment, the thermistor 106 may be only partially contained within the path length portion 102, with one or more portions of the thermistor 106 on the exterior of the sensor 100, in the transducer portion 120, or both.

Additionally, while the thermistor 106 is used as a temperature sensor in the depicted embodiment, in different embodiments (not depicted) a different type of temperature sensor may be used. For example, a thermocouple or a resistance thermometer may be used instead of or in addition to the thermistor 106.

As another example, while in the depicted embodiments the sensor 100 comprises a sensor head that is releasably couplable into the base 110, in different embodiments (not depicted) the functionality of the sensor head and base 110 may be combined into an integrated unit, or the logging functionality of the base 110 may be omitted entirely (e.g., the sensor 100 of FIGS. 1A-G may store measurements in the memory 138 and then directly send them to an external processor via the communications port 116). While the sensor head and base 110 of the depicted embodiments communicate digitally, in different embodiments (not depicted) communication may be analog or mixed digital and analog.

Directional terms such as “top”, “bottom”, “up”, “down”, “front”, and “back” are used in this disclosure for the purpose of providing relative reference only, and are not intended to suggest any limitations on how any article is to be positioned during use, or to be mounted in an assembly or relative to an environment. The term “couple” and similar terms, and variants of them, as used in this disclosure are intended to include indirect and direct coupling unless otherwise indicated. For example, if a first component is communicatively coupled to a second component, those components may communicate directly with each other or indirectly via another component. Additionally, the singular forms “a”, “an”, and “the” as used in this disclosure are intended to include the plural forms as well, unless the context clearly indicates otherwise.

The word “approximately” as used in this description in conjunction with a number or metric means within 5% of that number or metric.

It is contemplated that any feature of any aspect or embodiment discussed in this specification can be implemented or combined with any feature of any other aspect or embodiment discussed in this specification, except where those features have been explicitly described as mutually exclusive alternatives.

1. A sound velocity sensor for underwater use, the sound velocity sensor comprising:
(a) an acoustic transmitter for generating an acoustic signal;
(b) an acoustic receiver for receiving the acoustic signal;
(c) a path length portion defining an acoustic path and positioned such that the acoustic signal propagates along the acoustic path from the acoustic transmitter to the acoustic receiver;
(d) a temperature sensor in direct contact with the path length portion; and
(e) a controller communicatively coupled to the temperature sensor, acoustic transmitter, and acoustic receiver, wherein the controller is configured to:
(i) generate the acoustic signal using the acoustic transmitter;
(ii) determine a transit time of the acoustic signal from the acoustic transmitter to the acoustic receiver;
(iii) determine a temperature of the path length portion using the temperature sensor; and
(iv) determine the velocity of the acoustic signal from the transit time and a length of the acoustic path, wherein determining the velocity comprises compensating for a temperature-related change in the length of the acoustic path using the temperature of the path length portion.

2. The sound velocity sensor of claim 1 wherein the temperature sensor is at least partially embedded within the path length portion.

3. The sound velocity sensor of claim 2 wherein the temperature sensor is entirely embedded within the path length portion.

4. The sound velocity sensor of claim 1 further comprising a base, the base comprising a logging board communicatively coupled to the controller, wherein the acoustic transmitter, the acoustic receiver, the path length portion, and the temperature sensor comprise part of a sensor head that is releasably couplable to the base.

5. The sound velocity sensor of claim 4 wherein the controller comprises part of the sensor head.

6. The sound velocity sensor of claim 4 wherein the controller comprises part of the base.

7. The sound velocity sensor of claim 1 wherein the controller compensates for the temperature-related change in length of the acoustic path by:
(a) determining an uncompensated velocity value without taking into account the temperature of the path length portion determined using the temperature sensor; and
(b) scaling the uncompensated velocity value by a temperature scaling factor determined using a coefficient of thermal expansion of the path length portion and the temperature of the path length portion.

8. The sound velocity sensor of claim 1 wherein the acoustic signal propagates from the acoustic transmitter to the acoustic receiver without being reflected.

9. The sound velocity sensor of claim 1 wherein the acoustic transmitter and acoustic receiver comprise part of an acoustic transducer, and the path length portion comprises an acoustic reflector positioned to direct a reflection of the acoustic signal back to the acoustic transducer.

10. The sound velocity sensor of claim 9 wherein the controller is further configured to:
(a) determine a maximum amplitude of the reflection;
(b) compare the maximum amplitude to a reflection threshold; and
(c) when the maximum amplitude is less than the reflection threshold, generate another acoustic signal of larger amplitude than the acoustic signal that is the source of the reflection.

11. The sound velocity sensor of claim 9 wherein:
(a) the reflection comprises a first reflection;
(b) the acoustic signal reverberates between the acoustic transducer and the acoustic reflector, and reverberations between the acoustic transducer and the acoustic reflector comprise the first reflection and a second reflection of the acoustic signal off the acoustic reflector; and
(c) determining the transit time comprises determining a time difference between receiving the first and second reflections at the acoustic transducer.

12. The sound velocity sensor of claim 11 wherein the first and second reflections are the first and second reflections of the acoustic signal that the acoustic transducer receives.

13. The sound velocity sensor of claim 11 wherein determining the time difference between receiving the first and second reflections comprises performing a cross-correlation of the first and second reflections.

14. The sound velocity sensor of claim 1 wherein determining the transit time of the acoustic signal comprises obtaining and averaging samples of the acoustic signal as measured by the acoustic receiver, determining the temperature of the path length portion comprises obtaining and averaging samples of the temperature as measured by the temperature sensor, and the temperature is sampled at a higher frequency than the acoustic signal.

15. A method for determining underwater sound velocity, the method comprising:
(a) generating an acoustic signal underwater;
(b) directing the acoustic signal along an underwater acoustic path, wherein the acoustic path is defined by a path length portion that directly contacts a temperature sensor;
(c) determining a transit time of the acoustic signal along the acoustic path;
(d) determining a temperature of the path length portion using the temperature sensor; and
(e) determining the velocity of the acoustic signal from the transit time and a length of the acoustic path, wherein determining the velocity comprises compensating for a temperature-related change in the length of the acoustic path using the temperature of the path length portion.

16. The method of claim 15 wherein the temperature sensor is at least partially embedded within the path length portion.

17. The method of claim 16 wherein the temperature sensor is entirely embedded within the path length portion.

18. The method of claim 15 wherein compensating for the temperature-related change in the length of the acoustic path comprises:
(a) determining an uncompensated velocity value without taking into account the temperature of the path length portion determined using the temperature sensor; and
(b) scaling the uncompensated velocity value by a temperature scaling factor determined using a coefficient of thermal expansion of the path length portion and the temperature of the path length portion.

19. The method of claim 15 wherein directing the acoustic signal is done without reflecting the acoustic signal.

20. The method of claim 15 wherein directing the acoustic signal comprises reflecting the acoustic signal back towards a source of the acoustic signal.

21. The method of claim 20 further comprising:
(a) determining a maximum amplitude of a reflection resulting from reflecting the acoustic signal;
(b) comparing the maximum amplitude to a reflection threshold; and
(c) when the maximum amplitude is less than the reflection threshold, generating another acoustic signal of larger amplitude than the acoustic signal that is the source of the reflection.

22. The method of claim 20 wherein:
(a) reflecting the acoustic signal causes the acoustic signal to reverberate along the acoustic path, wherein reverberations comprise a first reflection and a second reflection; and
(b) determining the transit time comprises determining a time difference between receiving the first and second reflections at an acoustic receiver.

23. The method of claim 22 wherein the first and second reflections are the first and second reflections of the acoustic signal that the acoustic receiver receives.

24. The method of claim 22 wherein determining the time difference between receiving the first and second reflections comprises performing a cross-correlation of the first and second reflections.

25. The method of claim 15 wherein determining the transit time of the acoustic signal comprises obtaining and averaging samples of the acoustic signal, determining the temperature of the path length portion comprises obtaining and averaging samples of the temperature as measured by the temperature sensor, and the temperature is sampled at a higher frequency than the acoustic signal.

26. A non-transitory computer readable medium having encoded thereon computer program code that is executable by a processor, wherein the computer program code, when executed, causes the processor to perform a method for determining underwater sound velocity, the method comprising:
(a) generating an acoustic signal underwater;
(b) directing the acoustic signal along an underwater acoustic path, wherein the acoustic path is defined by a path length portion that directly contacts a temperature sensor;
(c) determining a transit time of the acoustic signal along the acoustic path;
(d) determining a temperature of the path length portion using the temperature sensor; and
(e) determining the velocity of the acoustic signal from the transit time and a length of the acoustic path, wherein determining the velocity comprises compensating for a temperature-related change in the length of the acoustic path using the temperature of the path length portion.
